(19) United States
(12) Patent Application Publication
(10) Pub. No.: US 2026/0285384 A1
(43) Pub. Date: Sep. 24, 2026

(54) WORKSTATION WHEEL ASSEMBLY

(71) Applicant: Lenovo (United States) Inc., Morrisville, NC (US)

(72) Inventors: Bryan Binda, Cary, NC (US); Madhab Dash, Morrisville, NC (US); Jean J. Xu, Cary, NC (US); James Michael Dupuy, Carry, NC (US)

(21) Appl. No.: 19/084,534

(22) Filed: Mar. 19, 2025

(51) Int. Cl. B62B 5/00

(52) U.S. Cl. CPC B62B 5/0086

(57) ABSTRACT

A wheel assembly includes a crossbar having a length corresponding to at least a length of a handle of a computer workstation chassis. The crossbar includes a first retentive guide extending out from a top surface of the crossbar to mate with a first lateral edge of the handle and a second retentive guide extending out from the top of the crossbar to mate with a second lateral edge of the handle. A clip is coupled to the top surface of the crossbar configured to retentively engage an inside surface of the handle. First and second wheels are coupled to a bottom of the crossbar and are laterally spaced apart from each other.

### BACKGROUND

Desktop computer workstations can be very heavy. The addition of graphics processor can increase the weight to 70 lbs or more. Heavy desktop computer workstations can be very difficult to move, even when using handles that are built into a chassis of the workstation. While hand trucks, carts, and dollies may be used to move workstations, additional straps are commonly used to secure the workstations to the hand trucks, carts, or dollies.

### SUMMARY

A wheel assembly includes a crossbar having a length corresponding to at least a length of a handle of a computer workstation chassis. The crossbar includes a first retentive guide extending out from a top surface of the crossbar to mate with a first lateral edge of the handle and a second retentive guide extending out from the top of the crossbar to mate with a second lateral edge of the handle. A clip is coupled to the top surface of the crossbar configured to retentively engage an inside surface of the handle. First and second wheels are coupled to a bottom of the crossbar and are laterally spaced apart from each other.

### BRIEF DESCRIPTION OF THE DRAWINGS

FIG. 1 is a perspective view of a computer workstation having attached wheel assemblies and coupled to provide mobility to the workstation according to an example embodiment.

FIG. 2 is a perspective view of the wheel assembly according to an example embodiment.

FIG. 3 is a perspective view of an alternative wheel assembly coupled to a chassis handle of a workstation according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Desktop workstations can be very heavy. One technical challenge is how to provide mobility for heavy workstations without modifying a workstation chassis and without the need for tools.

A small form factor crossbar with laterally spaced wheels form a wheel assembly to attach to unmodified desktop workstations without the need for tools to provide mobility to the workstation. The use of two wheel assemblies, each attached to chassis handles of a workstation, allows for toolless installation of wheel assemblies and ease of movement of the workstation. Since handles are designed to carry the workstations, using the handles to retain the wheel assembly properly distributes the weight of the workstation through the wheels.

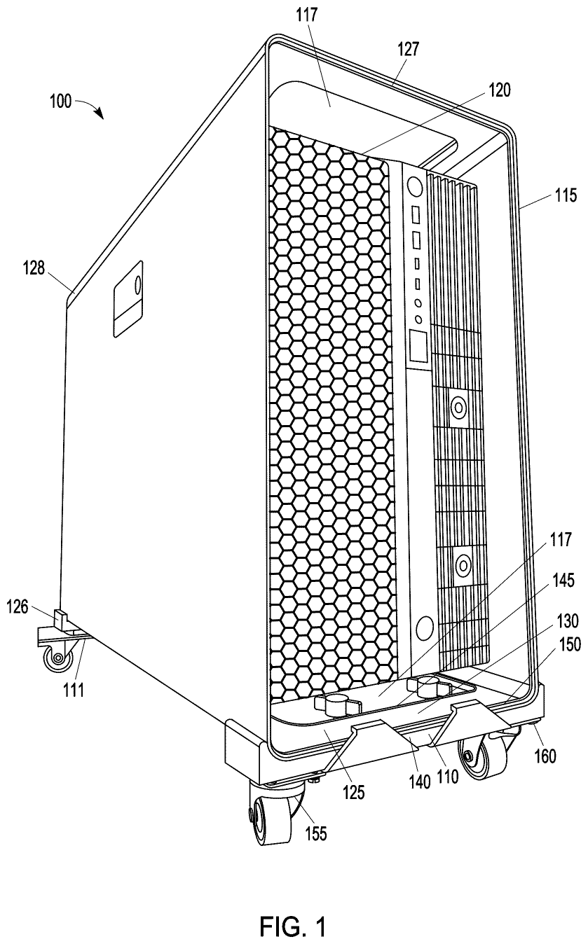

FIG. 1 is a perspective view of a computer workstation 100 having attached wheel assemblies 110 and 111 coupled to provide mobility to the workstation. Workstation 100 includes a chassis 115 that holds computer electronics 120. In one example, the chassis 115 includes a handle 125 that is suitable for lifting the workstation 100. The handle 125 is positioned on a lower or bottom front end of the chassis 115. Further handles 126, 127, and 128 may be positioned on other ends of the workstation 100. Handle 125 includes an inside surface, flat section 130, extending between sides of the chassis 115 and also includes an opening 117 (also visible in handle 127) that is open and accessible on both sides of the handle to enable lifting of the workstation 100 by hand. The opening 117 may have curved edges in one example for providing a smoother appearance and more ergonomic function of avoiding sharp corners. In one example, both ends of the chassis 115 include handles 125 and 126 on at least a bottom of the chassis 115 and may also include handles 127 and 128 on a top of the chassis 115 as shown.

A wheel assembly 110 is shown coupled to handle 125. Wheel assembly 110 includes a crossbar 140 having a length corresponding to at least a length of the handle 125 of the computer workstation chassis 115. The crossbar 140 may be formed of hard plastic or other material suitable for holding the weight of the workstation 100 and may be injection molded, 3D printed using PCABS, or otherwise fabricated.

Wheel assembly 111 is formed consistent with the first wheel assembly 110 and is shown coupled to handle 126 to provide for ease of moving the workstation. Wheel assembly 110 is coupled to first and second lateral edges 145 and 150 of handle 125. Wheel assembly 111 may be similarly coupled to lateral edges of handle 126.

Wheel assembly 110 includes two laterally spaced apart casters 155 and 160 coupled to a bottom of the crossbar 140 via screws, glue, or other means of securely coupling the casters 155 and 160 to the crossbar 140. The casters 155 and 160 are separated a distance sufficient to provide stability of the workstation 100 during movement of the workstation 100. In one example, the crossbar 140 has a length that extends beyond a width of the chassis with the casters coupled to the crossbar laterally spaced a distance at or greater than a width of the chassis to provide further stability for narrower workstations.

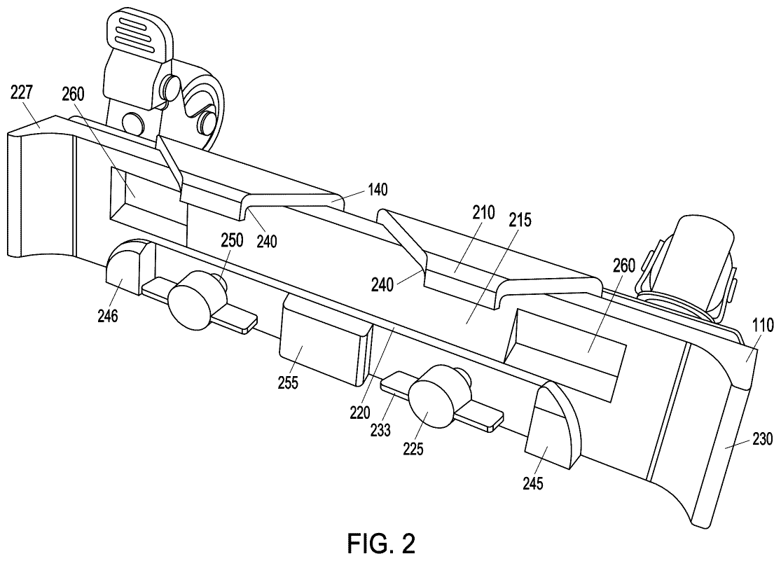

FIG. 2 is a perspective view of the wheel assembly 110. The wheel assembly 110 is described in detail with reference to both FIG. 1 and FIG. 2 and includes a first retentive guide 210 extending out from a top surface 215 of the crossbar 140 to mate with the second lateral edge 150 of the handle 125. A second retentive guide 220 extends out from the top surface 215 of the crossbar 140 to mate with the first lateral edge 145 of the handle.

A clip 225 is coupled to the top surface 215 of the crossbar 140 and is configured to retentively engage the flat section 130 of the handle 125. The crossbar in one example has ends 227 and 230 shaped to conform with an outside of the chassis, which is shown as rounded.

In one example, the clip 225 is a rotatable thumb screw in threaded engagement with the crossbar 140 and has a leg 233 configured to engage the flat section 130 of the handle 125 by rotating the leg 233 into engagement with the flat section 130 of the handle 125. In further examples, the clip 225 may be a T-shaped thumb screw as shown in threaded engagement with the crossbar 140 that is configured to engage the flat section 130 of the handle 125. In still further examples, the clip 225 may be a clamp, latch, fastener, captive screw, or other means of retaining the wheel assembly 110 to the handle 125.

The first retentive guide 210 includes a lip 240 to engage an inside surface of the handle 125, flat section 130. The top surface 215 of the crossbar 140 is shaped to engage on outside surface of the handle 125. In one example, the first retentive guide 210 includes two protrusions extending out from a top of the crossbar, each having lip 240 to engage the inside surface of the handle, flat section 130. While flat section 130 of the handle 125 is referred to as flat, it need not be perfectly flat but should be configured to be retentively engaged by the lip 240 and clip 225.

The second retentive guide may include 220 two laterally spaced chamfered inside handle edge engaging protrusions 245, 246. The edge engaging protrusions may include rounded corners to conform to curved corners of the handle. Second retentive guide 220 may also include a second handle engaging protrusion 250 spanning between the two laterally spaced chamfered inside handle edge engaging protrusions 245, 246 and may also include a middle, chamfered handle engaging protrusion 255 extending out from the top of the crossbar further than the second handle engaging protrusion. Each of the protrusions of the retentive guide 220 serve to key the wheel assembly into position on the handle 125 to nest the handle on the top surface 215 of the wheel assembly 110 and retain the wheel assembly and handle 125 into a secured position via operation of clip 225.

In one example the crossbar 140 includes one or more indents or recesses 260 configured to fit one or more standoffs or feet of the chassis 115. In one example, the crossbar 140 has a length wider than the chassis and wherein the wheels are coupled to the crossbar laterally spaced a distance at or greater than a width of the chassis.

To install wheel assembly 110 onto handle 125, handle 127 may be used to lift the chassis at handle 125 off the ground a sufficient height to enable insertion of the crossbar 140 and engagement of the lip 240 with the flat section 130 of the handle 125. The wheel assembly 110 is then rotated to place the outside surface of the handle 125 onto the top surface of the crossbar 140. The second retentive guides are used as a keying mechanism to guide the top surface of the crossbar 140 into engagement with the outside surface of the handle 125. One or more clips 225 may then be rotated or otherwise engaged with the flat section 130 of the handle 125 to retentatively attach or lock into place the wheel assembly to the handle 125. Wheel assembly 111 may be similarly installed on handle 126. The second retentive guide protrusions 245 and 246 help both guide the wheel assembly into proper contact with the handle 125 and also serve to laterally key the handle onto the surface of the crossbar 140 by ensuring curves of the handle 125 mate with corresponding curves of protrusions 245 and 246.

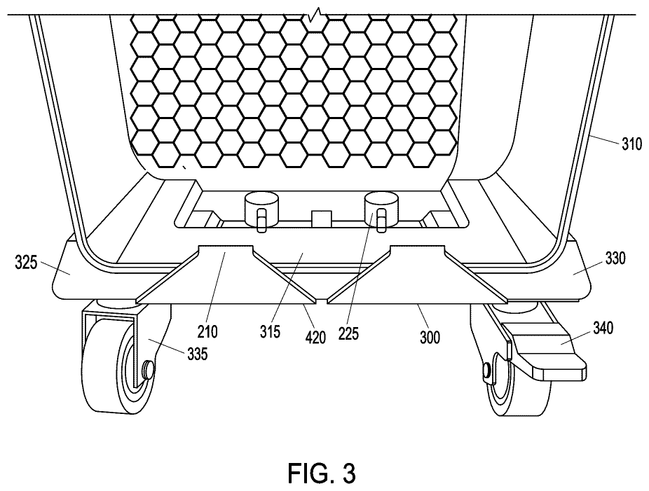

FIG. 3 is a perspective view of an alternative wheel assembly 300 coupled to a chassis 310 handle 315 of a workstation. Wheel assembly 300 includes a crossbar 320 having many elements in common with and numbered consistently with crossbar 140. In addition, crossbar 320 is formed longer than a width of the chassis. Additional width of the crossbar 320 is provided by forming wings 325 and 330 that extend at least partly further than and outside sides of chassis 310. This extension of the crossbar 320 enables the attachment of casters 335 and 340 to the bottom of the crossbar at or outside the edges of the chassis 310. In further embodiments, the wings may be formed even further beyond the outside edges of the chassis 310 to provide increased stability along with mobility of thinner, yet heavy workstations to prevent workstations from tipping over during movement.

### EXAMPLES

1. A wheel assembly includes a crossbar having a length corresponding to at least a length of a handle of a computer workstation chassis. The crossbar includes a first retentive guide extending out from a top surface of the crossbar to mate with a first lateral edge of the handle and a second retentive guide extending out from the top of the crossbar to mate with a second lateral edge of the handle. A clip is coupled to the top surface of the crossbar configured to retentively engage an inside surface of the handle. First and second wheels are coupled to a bottom of the crossbar and are laterally spaced apart from each other.
2. The wheel assembly of example 1 wherein the wheels are casters.
3. The wheel assembly of any of examples 1-2 wherein the clip includes a rotatable thumb screw in threaded engagement with the crossbar and having a leg configured to engage the inside surface of the handle.
4. The wheel assembly of any of examples 1-3 wherein the clip includes a T-shaped thumb screw in threaded engagement with the crossbar configured to engage the inside surface of the handle.
5. The wheel assembly of any of examples 1-4 wherein the first retentive guide includes a lip to engage the inside surface of the handle and wherein the top of the crossbar is shaped to engage on outside surface of the handle.
6. The wheel assembly of any of examples 1-5 wherein the first retentive guide includes two protrusions extending out from a top of the crossbar, each having a lip to engage the inside surface of the handle.
7. The wheel assembly of any of examples 1-6 wherein the second retentive guide includes two laterally spaced chamfered inside handle edge engaging protrusions.
8. The wheel assembly of example 7 wherein the second retentive guide includes a second handle engaging protrusion spanning between the two laterally spaced chamfered inside handle edge engaging protrusions and a middle chamfered handle engaging protrusion extending out from the top of the crossbar further than the second handle engaging protrusion.
9. The wheel assembly of any of examples 1-8 wherein the crossbar further comprises a recess configured to fit a standoff of the chassis.
10. The wheel assembly of any of examples 1-9 wherein the crossbar further includes ends shaped to conform with an outside of the chassis.
11. The wheel assembly of any of examples 1-10 wherein the crossbar has a length wider than the chassis and wherein the wheels are coupled to the crossbar laterally spaced a distance at or greater than a width of the chassis.
12. A wheel assembly includes a crossbar having a length corresponding to at least a length of a handle of a computer workstation chassis. The crossbar includes two laterally spaced first retentive protrusions extending out from a top surface of the crossbar, each having a lip to mate with an inside lateral edge of the handle and second retentive guides extending out from the top of the crossbar to mate with an outside lateral edge of the handle. Two clips are coupled to the top surface of the crossbar, each opposite the first retentive protrusions and configured to retentively engage an inside surface of the handle. First and second wheels are coupled to a bottom of the crossbar and are laterally spaced apart from each other.
13. The wheel assembly of example 12 wherein the wheels include casters.
14. The wheel assembly of any of examples 12-13 wherein the clip includes a rotatable thumb screw in threaded engagement with the crossbar and having a leg configured to engage the inside surface of the handle.
15. The wheel assembly of any of examples 12-14 wherein the second retentive guides include two laterally spaced chamfered inside handle edge engaging protrusions.
16. The wheel assembly of example 15 wherein the second retentive guides include a second handle engaging protrusion spanning between the two laterally spaced chamfered inside handle edge engaging protrusions and a middle chamfered handle engaging protrusion extending out from the top of the crossbar further than the second handle engaging protrusion.
17. The wheel assembly of any of examples 12-16 wherein the crossbar further includes a recess configured to fit a standoff of the chassis.
18. The wheel assembly of any of examples 12-17 wherein the crossbar further includes ends shaped to conform with an outside of the chassis.
19. The wheel assembly of any of examples 12-18 wherein the crossbar has a length wider than the chassis and wherein the wheels are coupled to the crossbar laterally spaced a distance at or greater than a width of the chassis.
20. A wheel assembly includes a crossbar having a length corresponding to at least a length of a handle of a computer workstation chassis. The crossbar includes a top surface configured to mate with at least a portion of the handle, two laterally spaced first retentive protrusions extending out from the top surface of the crossbar, each having a lip to mate with an inside lateral edge of the handle, and second retentive guides extending out from the top of the crossbar to mate with an outside lateral edge of the handle. Two clips are coupled to the top surface of the crossbar, each opposite the first retentive protrusions and configured to retentively engage an inside surface of the handle. First and second wheels are coupled to a bottom of the crossbar and are laterally spaced apart from each other.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A wheel assembly comprising:
a crossbar having a length corresponding to at least a length of a handle of a computer workstation chassis, the crossbar comprising:
a first retentive guide extending out from a top surface of the crossbar to mate with a first lateral edge of the handle; and
a second retentive guide extending out from the top of the crossbar to mate with a second lateral edge of the handle;
a clip coupled to the top surface of the crossbar configured to retentively engage an inside surface of the handle; and
first and second wheels coupled to a bottom of the crossbar and laterally spaced apart from each other.

2. The wheel assembly of claim 1 wherein the wheels comprise casters.

3. The wheel assembly of claim 1 wherein the clip comprises a rotatable thumb screw in threaded engagement with the crossbar and having a leg configured to engage the inside surface of the handle.

4. The wheel assembly of claim 1 wherein the clip comprises a T-shaped thumb screw in threaded engagement with the crossbar configured to engage the inside surface of the handle.

5. The wheel assembly of claim 1 wherein the first retentive guide includes a lip to engage the inside surface of the handle and wherein the top of the crossbar is shaped to engage on outside surface of the handle.

6. The wheel assembly of claim 1 wherein the first retentive guide includes two protrusions extending out from a top of the crossbar, each having a lip to engage the inside surface of the handle.

7. The wheel assembly of claim 1 wherein the second retentive guide includes two laterally spaced chamfered inside handle edge engaging protrusions.

8. The wheel assembly of claim 7 wherein the second retentive guide includes a second handle engaging protrusion spanning between the two laterally spaced chamfered inside handle edge engaging protrusions and a middle chamfered handle engaging protrusion extending out from the top of the crossbar further than the second handle engaging protrusion.

9. The wheel assembly of claim 1 wherein the crossbar further comprises a recess configured to fit a standoff of the chassis.

10. The wheel assembly of claim 1 wherein the crossbar further comprises ends shaped to conform with an outside of the chassis.

11. The wheel assembly of claim 1 wherein the crossbar has a length wider than the chassis and wherein the wheels are coupled to the crossbar laterally spaced a distance at or greater than a width of the chassis.

12. A wheel assembly comprising:
a crossbar having a length corresponding to at least a length of a handle of a computer workstation chassis, the crossbar comprising:
two laterally spaced first retentive protrusions extending out from a top surface of the crossbar, each having a lip to mate with an inside lateral edge of the handle; and
second retentive guides extending out from the top of the crossbar to mate with an outside lateral edge of the handle;
two clips coupled to the top surface of the crossbar, each opposite the first retentive protrusions and configured to retentively engage an inside surface of the handle; and
first and second wheels coupled to a bottom of the crossbar and laterally spaced apart from each other.

13. The wheel assembly of claim 12 wherein the wheels comprise casters.

14. The wheel assembly of claim 12 wherein the clip comprises a rotatable thumb screw in threaded engagement with the crossbar and having a leg configured to engage the inside surface of the handle.

15. The wheel assembly of claim 12 wherein the second retentive guides include two laterally spaced chamfered inside handle edge engaging protrusions.

16. The wheel assembly of claim 15 wherein the second retentive guides include a second handle engaging protrusion spanning between the two laterally spaced chamfered inside handle edge engaging protrusions and a middle chamfered handle engaging protrusion extending out from the top of the crossbar further than the second handle engaging protrusion.

17. The wheel assembly of claim 12 wherein the crossbar further comprises a recess configured to fit a standoff of the chassis.

18. The wheel assembly of claim 12 wherein the crossbar further comprises ends shaped to conform with an outside of the chassis.

19. The wheel assembly of claim 12 wherein the crossbar has a length wider than the chassis and wherein the wheels are coupled to the crossbar laterally spaced a distance at or greater than a width of the chassis.

20. A wheel assembly comprising:
a crossbar having a length corresponding to at least a length of a handle of a computer workstation chassis, the crossbar comprising:
a top surface configured to mate with at least a portion of the handle;
two laterally spaced first retentive protrusions extending out from the top surface of the crossbar, each having a lip to mate with an inside lateral edge of the handle; and
second retentive guides extending out from the top of the crossbar to mate with an outside lateral edge of the handle;
two clips coupled to the top surface of the crossbar, each opposite the first retentive protrusions and configured to retentively engage an inside surface of the handle; and
first and second wheels coupled to a bottom of the crossbar and laterally spaced apart from each other.
